(19) United States
(12) Patent Application Publication
(10) Pub. No.: US 2019/0370647 A1
(43) Pub. Date: Dec. 5, 2019

(54) ARTIFICIAL INTELLIGENCE ANALYSIS AND EXPLANATION UTILIZING HARDWARE MEASURES OF ATTENTION

(71) Applicant: Intel Corporation, Santa Clara, CA (US)

(72) Inventors: Kshitij Doshi, Tempe, AZ (US); Michele Fisher, Hillsboro, OR (US); Rajesh Poornachandran, Portland, OR (US); Ranganath Krishnan, Hillsboro, OR (US); Carl Marshall, Portland, OR (US); Nilesh Jain, Portland, OR (US)

(73) Assignee: Intel Corporation, Santa Clara, CA (US)

(21) Appl. No.: 16/256,844

(22) Filed: Jan. 24, 2019

(51) Int. Cl. G06N 3/08; G06F 11/30; G06F 11/34; G06K 9/62

(52) U.S. Cl. CPC G06N 3/08; G06F 11/3037; G06K 9/6256; G06F 11/3065; G06F 11/3466

(57) ABSTRACT

Embodiments are directed to artificial intelligence (AI) analysis and explanation utilizing hardware measures of attention. An embodiment of a non-transitory computer-readable storage medium has stored thereon executable computer program instructions for: monitoring one or more factors of an AI network during operation of the network, the network to receive input data and output a decision based at least in part on the input data; determining attention received by the one or more factors of the network during the operation of the network; determining one or more relationships between the attention received by the one or more factors and a decision of the network based at least in part on the monitored information; and generating an analysis of the operation of the network based at least in part on the one or more relationships between attention received by the one or more factors and the decision of the network.

### TECHNICAL FIELD

Embodiments described herein relate to the field of computing systems and, more particularly, artificial intelligence analysis and explanation utilizing hardware measures of attention.

### BACKGROUND

A deep neural network (DNN) is an artificial neural network that includes multiple neural network layers. Broadly speaking, neural networks operate to spot patterns in data, and provide decisions based on such patterns. Artificial intelligence (AI) is being applied utilizing DNNs in many new technologies.

However, the internal operation of an AI network is generally not visible, which can raise questions about how the results of a network are being produced. For this reason, developers wish to gain visibility into how decisions are reached in processing systems, including deep neural networks, thus providing explainability of the system. Explainability of a system may include explainability of operation both during training and inference of the network, such as in operation of a neural network.

Determinations regarding how results are reached in a system may in theory be provided by adding instrumentation in software so that any decision or pattern classification includes a data-referenced trace, in the same way that a programmer can debug or trace the execution of their code by instrumenting every instruction and data variable referenced. However, direct code instrumentation of a complex processing system is prohibitively expensive and cumbersome, which is why, even when used as a debugging aid in non-neural code, instrumentation is commonly activated progressively over smaller and smaller regions of code to zoom in on an error, which may be over long periods of debugging operations.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of network monitoring and analysis according to some embodiments;

FIG. 2 is an illustration of an apparatus or system to provide network performance monitoring and analysis for explainable artificial intelligence according to some embodiments;

FIG. 3 is an illustration of attention tracking and sampling in an apparatus or system according to some embodiments;

FIG. 4 is an illustration of attention tracking and sampling in an apparatus or system according to some embodiments;

FIG. 5 is a flowchart to illustrate a process for of monitoring and analysis of a network such as a neural network according to some embodiments;

FIG. 6 illustrates artificial intelligence analysis and explanation utilizing hardware measures of attention in a processing system according to some embodiments;

FIG. 7 illustrates a computing device according to some embodiments;

FIG. 8 is a generalized diagram of a machine learning software stack; and

FIGS. 9A-9B illustrate an exemplary convolutional neural network.

### DETAILED DESCRIPTION

Embodiments described herein are directed to artificial intelligence analysis and explanation utilizing hardware measures of attention.

In some embodiments, an apparatus, system, or process includes elements, including hardware measures, for revealing how a network reaches a particular decision. The network may include, but is not limited to, a neural network generating a classification or other decision in inference or training. In some embodiments, through measurement of reference load (which may be referred to herein as “attention” or “factor attention”) that is received by various factors (which may include certain subpatterns of factors) that contribute to the decision, and the reference load received, in turn, by various factors that contribute to the identification of subpatterns, information regarding network operation may be obtained and revealed for purposes of analysis, understanding, or forensics. The hardware measures may be provided through additions or extensions to the capabilities of a performance monitoring unit (PMU) or other similar element provided for performance monitoring. In some embodiments, hardware measures of attention may be applied to central processing units (CPUs), graphics processing units (GPUs), and other computational elements.

As referred to herein, “attention” or “factor attention” refers to contribution by a factor in decisions, which may be utilized to reveal the anatomy of a decision by a network with regard to which factors in various layers of the network contributed more, and which factors contributed less, to various decisions. Thus, attention relates to the observation of the reference load received by relevant factors during the operation of a network model. It is noted that this is different than the use of the term “attention” with regard to concepts of attention-based inference techniques, such as those used in translating from a source language to a target language in natural language processing. In NMT (neural machine translation) techniques, “attention” refers to the relevance given to words in source language when translating a phrase to the target language, and which is itself a part of the inferencing mechanism.

A network model, such as a neural network model, can be viewed as a memory map indicating where features are in terms of memory location. In some embodiments, a developer or programmer may plant watchpoints over certain interesting variables that represent factors for the network, in effect receiving assistance from system hardware to observe when a key variable is accessed or modified, and thus receives attention information for the variable in operation. In some embodiments, an apparatus, system, or process includes a performance monitoring unit (PMU) to collect read and write statistics over variables for factors. In some embodiments, the apparatus, system, or process is to determine the level of attention being directed in reads and writes for variables. This relates to a certain level of access, with access meaning that something is done with the value (as opposed to, for example, simply reading a zero value and taking no action).

In some embodiments, new explainable proxy variables may be introduced in training of a network at multiple levels, and the amount of attention these variables receive, as well as the amount of energy spent in reaching their corresponding activations, can be used by deployers as means of understanding, auditing, and feeding back into model training for continued refining of explainability as well as accuracy of models. The amount of energy spent may be observed (measured) in some embodiments directly with processor energy counters such as those available with Intel® RAPL (Running Average Power Limit), or it may be derived by measuring numbers and types of instructions executed in the course of a decision and using an energy estimation model to translate these into energy expended. Energy may also be measured in terms of the numbers of features that change as a result of very modest changes in the input or in model coefficients.

Explainability of a network includes multiple aspects, including the degree to which a given input pattern contributes to a resulting network output. In some embodiments, an apparatus, system, or process measures energy related to the generation of a decision. By measuring an amount of energy spent in reaching decisions, the distance of an unknown pattern from a standard or representative input can be calibrated. This information is useful as a forensic measure over network models, the data used to train them, and the inferences the models produce in operation. The measures of attention and energy may not be sufficient by themselves to provide conclusions, but these can provide a significant degree of insight when combined with other techniques for decipherability, such as the addition of confidence measures for decisions.

In some embodiments, an apparatus, system, or process may use compact indication to further reduce the amount of data to be accessed in network monitoring, such as in the operation by a PMU. As used herein, compact indication refers to capture of a limited or reduced data such as, for example, capturing only the high level and low level bits of addresses or numerals corresponding to those addresses (in general collecting less than all data relating to the addresses), as opposed to collecting full 64-bit locations. This is in contrast with the operation of a conventional PMU, which would be unable to observe the large number of values required to fully track the operations of an AI network. Instead, in an embodiment the PMU is directed to a compact region for collection of metrics for an AI network.

In some embodiments, a PMU may be used to measure relative energy to obtain a relative measure of the strength of evidence in favor of a classification or regression performed by a trained model. As an analogy, it may be considered how owners learn to, for example, recognize their bags at a conveyor belt. The owners are mentally tuned (or trained) to look for the distinctive few features that allow the owner to quickly discriminate a much smaller set of bags. Similarly, a person may discover a few nuances to quickly identify another person from voice, from their gait, and so on. This insight is translated into applying to AI models by noting that a well-trained model may not need to spend a large of energy in reaching a conclusion except for the rare cases of confusing, ambiguous, or noisy inputs. An apparatus or system can instead reach a fuzzy version of a decision with low energy (such as by using a high amount of random dropout during inference, or by using very low precision inference), and then the apparatus or system can retake the actual inference at full precision. If the two results do not diverge, then the low energy fuzzy inference across multiple perturbations of input would indicate that the decision was both simple and accurate even when it was taken in a hurry.

In some embodiments, an apparatus, system, or process may further include one or more of the following:

(1) Measurement of relative energy required to reach a decision. In some embodiments, in model construction various factors may be introduced and then specified to the PMU for access tracing and for measuring relative energy. A process may include looking at how a system operates with a low precision/low energy model, and then add precision to the model. If not much changes, then the decision may be deemed to require low energy (and therefore invite higher confidence or merit being treated as more stable, simpler, and possessing the “Occam's Razor” quality).

(2) Identification of features that are important and stand out in monitoring and analysis. If certain factors received a high level of attention, then the apparatus, system, or process may include varying level of precision to determine if safe inferences can be made with a different precision.

(3) Application in training as well as in inference or other decision-making operation. For example, if certain factors are not receiving enough attention during training of a network, the apparatus, system, or process may augment the input with additional examples of the factors to address the attention deficiency.

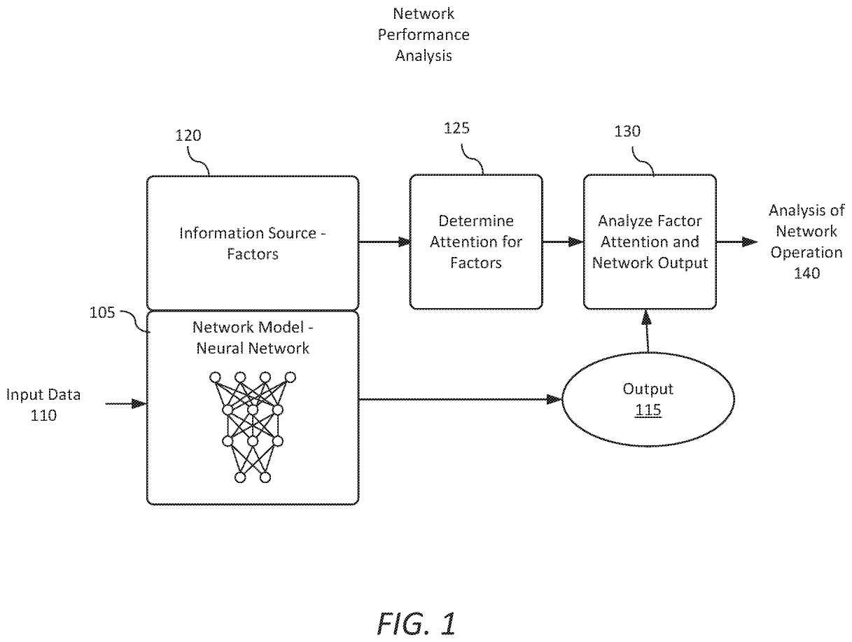

FIG. 1 is an illustration of network monitoring and analysis according to some embodiments. In some embodiments, the network monitoring and analysis includes monitoring of hardware measures of attention for a network, including, for example, monitoring of a neural network 105. A network may alternatively be, for example, blocks for computer vision or other computational network.

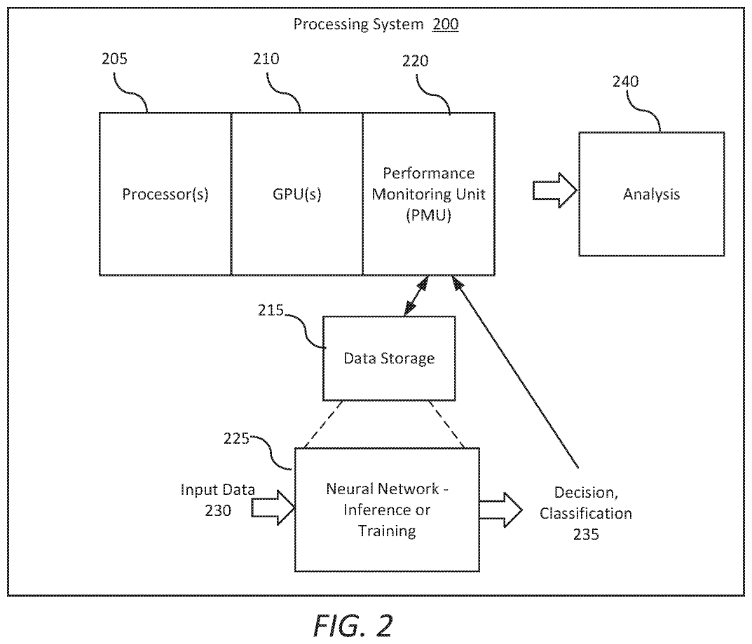

In some embodiments, the monitoring includes monitoring of an information source 120. The information source 120 may include, but is not limited to, a data storage (such as a computer memory or other storage allowing for the storage of data connected with a network) containing variables that may be monitored during operation, such as during inference or training of the illustrated neural network 105, wherein the variables represent factors for generation of the output of the network. An example of an information source is data storage 215 illustrated in FIG. 2. The information source 120 may also include storage for code addresses, IP blocks, or other information. As illustrated, the neural network 105 receives input data 110 and produces an output 115, which may include a decision or classification from neural network inference.

In some embodiments, an apparatus, system, or process is to determine attention 125 directed to each monitored factor. In some embodiments, the factor attention 125 is analyzed 130 together with the output of the network 115 to generate an analysis of relationships between the network output and factor attention 140, wherein the analysis may be used to provide an explanation regarding how the network 105 arrives at a particular decision in terms of attention received by certain factors.

In some embodiments, the network monitoring and analysis may further include measurement of the energy, including relative energy, required to generate a decision by the network.

In some embodiments, the network analysis in an apparatus, system, or process may be viewed as equivalent to, for example, a “double-click” on the decision generated by the network to open up information relating to the bases for the decision, and thus contribute a degree of transparency to decisions from a network model, depending on the choice of the factors on which the attention is being measured. In some embodiments, in model construction various such factors may be introduced and then specified to the new PMU logic for access tracing and for measuring relative energy.

FIG. 2 is an illustration of an apparatus or system to provide network performance monitoring and analysis for explainable artificial intelligence according to some embodiments. As shown in FIG. 2, a processing system 200 includes one or more processors 205, which may for example include one or more CPUs (Central Processing Units) (which may operate as a host processor), having one or more processor cores, and one or more graphics processing units (GPUs) 210 having one or more graphics processor cores, wherein the GPUs may be included within or separate from the one or more processors 205. GPUs may include, but are not limited to, general purpose graphics processing units (GPGPUs). The processing system 200 further includes a data storage 215 (such as a computer memory) for the storage for data, including data for network processing, such as inference or training of a neural network 225, as illustrated in FIG. 2. The data storage 215 may include, but is not limited to, dynamic random-access memory (DRAM).

In some embodiments, the processing system 200 includes a performance monitoring unit (PMU) 220 that is to monitor factor attention in operation of a network, such as neural network 225. Information regarding the factor attention may be utilized for purposes of generating an analysis 240 of the operation of a network in terms of relationships between factor attentions and a network decision. The analysis may be generated by the PMU 220 or by another element of the processing system 200, such as by one or more processors 205 or GPUs 210 of the processing system. The analysis may also be generated by a trained neural network that may be implemented as a software model on a CPU or a GPU or as a cloud based service, or directly as fixed function hardware.

In some embodiments, the PMU 220 is to monitor variables in the data storage 215 to determine the attention that is directed to each factor in the generation of an output of the network. The network may include a neural network 225, wherein the neural network is to receive input data (which may include training data) 230 for inference or training, and is to produce decisions or classifications 235 as a result of the inference process. In some embodiments, the operation may also be applied in training of a neural network.

In some embodiments, the PMU 220 includes a capability to capture highly compact indications of which data addresses are being accessed, as well as which code locations are being exercised. As used herein, compact indication refers to capture of a limited or reduced data such as, for example, capturing only the high level and low level bits of addresses or numerals corresponding to those addresses, as opposed to collecting full 64-bit locations. A limited size hardware data structure designed for reservoir sampling is sufficient for this purpose because the neuron values or activations that get updated and which in turn update successive layers in any given pattern classification are a very small subset of the total number of neurons (weights, activations) in a neural network. The data sampling concept may be as discussed in “Random Sampling with a Reservoir” by Vitter, ACM Transactions on Mathematical Software, Vol. 11, No. 1, March 1985, Pages 37-57.

In some embodiments, input noise may be added to the input data 230 in order to determine how attentions received by the various factors are affected, and thus determine which factor have more immunity to the input noise. In some embodiments, the addition of input noise may further be utilized in determining which factors played a decisive role in changing a decision (if a decision change occurs).

In some embodiments, an apparatus, system or process includes the performance of multiple passes in a network, such as in a neural network for inference. For each pass the input to the neural network is varied by a small perturbation, such as by adding low levels of statistically independent Gaussian noise across the different parts of the input (pixels, voxels, phonemes, etc.). Providing such variation during inference allows PMU based profiling to collect data that illustrates a statistical distribution of attention that different portions of the memory and code bodies receive. This attention distribution, given a final inference/classification reached by a DL/ML (Deep Learning/Machine Learning) neural network model, may be applied to:

(1) Correlate the inference or classification with different variables, including those variables reflecting specific features or factors, to be associated with the classification, and to be logged for any postmortems; and

(2) If the individual features do not reflect specific human understandable factors, then factor vectors that map to specific factors (e.g., through principal components decomposition, for example), are used to relate the attention directed to the different features, to score how they contribute to the different human understandable factors.

In some embodiments, the performance metrics collected during network operation may be further divided into locations with non-subthreshold values (i.e., logical non-zeroes) locations that receive reads (“loads”), and locations that receive writes (“stores”). In this way, evidence may be produced to enable distinguishing between features that were identified immediately (thus there being almost no stores after a first store), or those features that required more time or more back and forth (oscillation) between whether the feature was identified and de-identified repeatedly, with the latter case indicating a higher level of ambiguity.

In some embodiments, an apparatus, system, or process combines the above method of tracking where the attention is directed, together with the amount of energy that is spent in the direction of that attention. In some embodiments, a hardware-based energy tracking mechanism is provided to obtain a relative measure of the strength of evidence in favor of a classification (also known as regression or a conclusion) performed by a trained model. When a model is sufficiently well trained, it should not expend a large amount of energy in reaching a conclusion, and thus the number of different activations it needs to rely on for its decision should be small. For this reason, with a small number of binary dropout iterations during inference, a measure of the relative amount of energy spent in its classification (both positive and negative) identifies whether that classification is one with a strong support. In addition to binary dropout, one may also perturb the inputs into the model by a small amount of noise, and evaluate the energy needed to produce the new result. The energy may be measured in, for example, units of surprise, this being the question of how many features change their activation from 0 to 1 or 1 to 0 in comparison to a reference prior setting in the network which is taken with a very fuzzy version of the input.

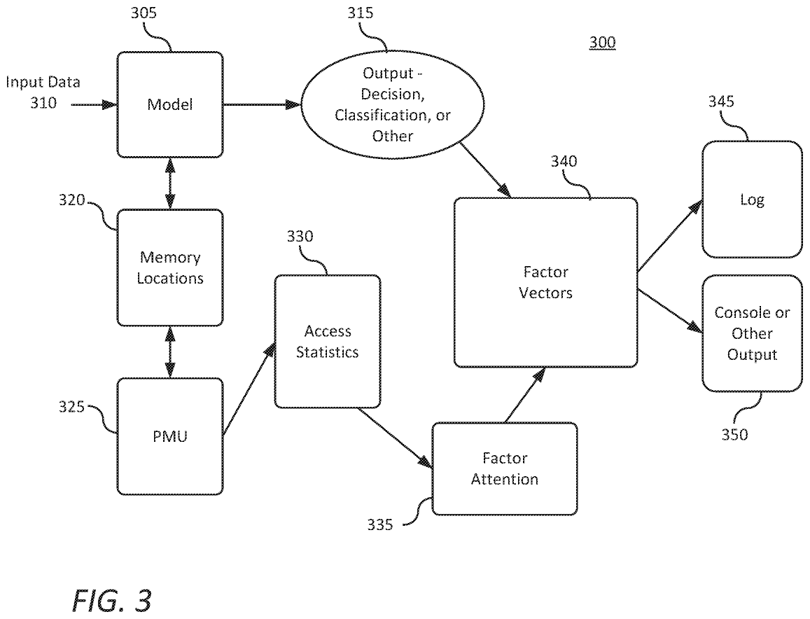

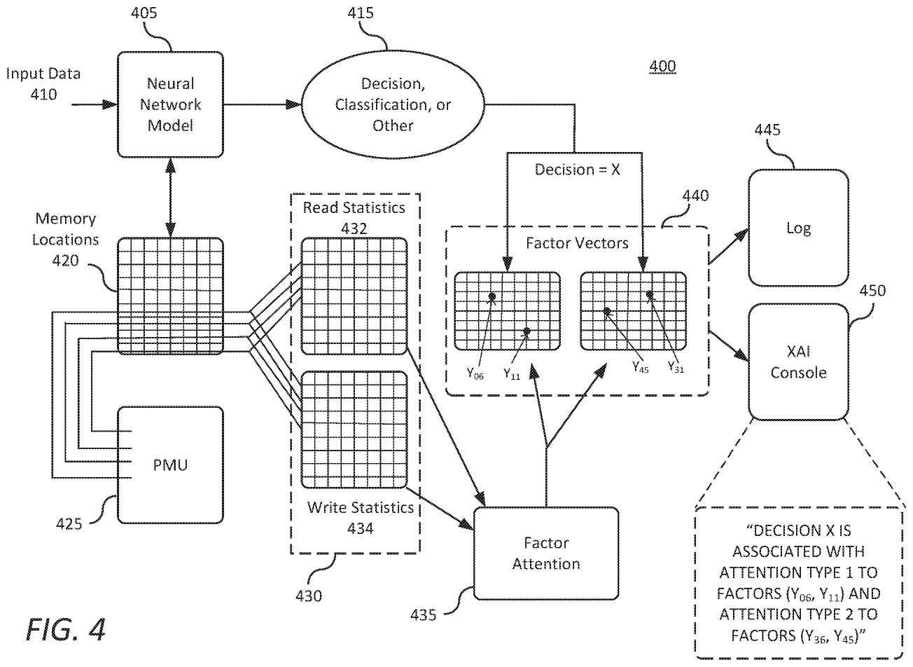

The operation of the PMU 220 is shown in further detail for certain implementations in FIGS. 3 and 4.

FIG. 3 is an illustration of attention tracking and sampling in an apparatus or system according to some embodiments. As illustrated in FIG. 3, input data 310 may be received by a network model 305, such as a neural network model in inference or training, with the model 305 producing an output, which may include a decision, classification, or other output 315. However, conventionally the actual decision-making process for the model 305 is not visible to a user. In some embodiments, the system includes memory locations 320 for variables representing factors that are tracked by a performance monitoring unit (PMU) 325. In some embodiments, the PMU 325 is to generate access statistics 330 related to the memory locations 320 during operation of the model 305.

In some embodiments, the access statistics 330 may be utilized to generate information regarding factor attention 335 in the model operation, such as the amount of attention in terms of access made to one or more factors. In some embodiments, the system then is to generate factor vectors 340 based upon the feature attentions 335 and the output 315, wherein the factor vectors may be utilized to provide explanation regarding the decision process of the model 305. The factor vectors may, for example, indicate a certain grade or measure of attention that is received by each of one or more factors in generating a particular decision with a particular set of input data. In some embodiments, the factor vectors may be output to one or more destinations, which may include a log 345 and a console or other output device 350 to allow a user to receive the artificial intelligence explanation output that has been produced.

FIG. 4 is an illustration of attention tracking and sampling in an apparatus or system according to some embodiments. FIG. 4 provides additional detail regarding an exemplary operation for attention tracking and sample. As illustrated in FIG. 4, input data 410 is provided to a network model, such as a neural network model in inference or training as shown in FIG. 4. The model 405 produces an output, which may include a decision, classification, or other output 415. In the illustrated example, the output 415 is a particular decision, Decision=X, wherein X can be any value or determination.

In some embodiments, the system includes memory locations 420, wherein certain memory locations for variables or features are tracked by a performance monitoring unit (PMU) 425. In some embodiments, the PMU 425 is to generate access statistics 430 related to the tracked memory locations 420 during operation of the model 405. In some embodiments, the access statistics 430 may include read statistics 432 tracking read operations for the memory locations 420, and write statistics 434 tracking write operations for the memory locations 420.

In some embodiments, the access statistics 430 may be utilized to generate information regarding feature attentions 435 in the model operation. In some embodiments, the system then is to generate factor vectors 440 based upon the feature attentions 435 and the output 415, wherein the factor vectors may be utilized to provide explanation regarding the decision process of the neural network 405. In the particular example illustrated in FIG. 4, factor vectors are determined to be factors Y₀₆ and Y₁₁ receiving a first grade or measure of attention (Attention Type 1, which may be a High level of attention in this example) and Y₄₅ and Y₃₁ for a second attention type (Attention Type 2, which may be a Medium High level of attention), indicate a certain grade or measure of attention that is received by each of one or more factors in generating a particular decision with a particular set of input data.

In some embodiments, analysis regarding the factor vectors may be provided to one or more output destinations, which may include a log 445 and a console or other output device 450, shown in FIG. 4 as an Explainable Artificial Intelligence (XAI) Console in FIG. 4, to allow a user to receive the artificial intelligence explanation output that has been produced. As shown in FIG. 4, the output is an explanation regarding the Decision=X, which in this example is: “DECISION X IS ASSOCIATED WITH ATTENTION TYPE 1 TO FACTORS (Y₀₆,Y₁₁) AND ATTENTION TYPE 2 TO FACTORS (Y₃₆,Y₄₅)”.

In the example illustrated in FIG. 4, the AI explanation indicates that when the model reaches a decision X, in the course of doing so for a given input, one aggregate grade-measure of attention (e.g., Type 1=High) categorized by attention type was received by variables representing two factors Y₀₆ and Y₁₁, while in the same decision another grade-measure of attention, (Type 2=Medium High), was received by factors Y₃₁ and Y₄₅.

In some embodiments, input noise may be added to the input data 410 and then the perturbation in the attentions received by the various factors is measured, so that the decision is further annotated by which of the factors were more, or less, immune to the input noise; and further determining which of the factors played a decisive role in changing a decision if there is a decision change.

In some embodiments, PMU samples may be seen as a way of evaluating, during training, as para-inputs or feedback inputs, reflecting how a knowledge of which factors during the training process reinforce and which do not reinforce a specific inference. As an example, it may be assumed that a network model is being trained to make a categorical decision, and a user is using the attention statistics as reflected in the PMU samples leading up to a particular categorical decision as a trace for that decision. Over time the user can see the attention statistics as a map relating the factors to decisions that are coming together or converging as the training continues through iterations. In this way, a higher confidence may be associated with a decision when the attention paid to many possible factors (or features) is well balanced. Users may trust a decision or outcome more when the decision rests lightly on many facts as opposed to resting heavily on a few, particularly if there is evidence that the few factors on which the decision rests are themselves indicating some high level of vacillation as measured by the attention.

Similarly, if there is some fragility in the way a model is trained, such as during supervised training the model is not paying attention to the right degree to certain features or factors (e.g., the training shows that the model is swayed to a high degree by some dominating features reflected in the input), then an embodiment may be utilized to identify the particular respects in which the input data may be augmented and filtered so that the training becomes more robust in terms of paying attention to the under-attended features. For example, in the manner in which children are taught to look left and right before crossing a road, and, if it is noticed that the child is frequently looking left but not right before crossing, then this may be taking as an indication that more attention needs to be paid to this facet of training, such as by overweighing situations in which the traffic is more frequently arriving from the right than from the left.

Factors (reflected by certain memory locations) that receive an outsized amount of attention may also be subject to different levels of precision during experiments. In some embodiments, a user or researcher may detect whether the precision of a frequently touched variable (for example in 8-bit/16-bit/32-bit/64-bit, etc., precision) matters in the effect it has in reaching safety critical decisions. In such cases, training can be increased or model complexity can be increased so that different types of hardware with different precision can reach safe inferences even if the precision each type of hardware supports is different. Optionally, features that are measured as receiving high levels of attention and whose precision needs to be good, may also be stored in memory/disks that are more hardened for resilience, security, or other purposes.

Embodiments to provide direct measurement of attention are not limited to memory locations accessed by a CPU. Embodiments may apply to any respect in which a PMU may be structured or enhanced to measure, for example, accesses to specific locations in various IP blocks, or to special registers or on-chip storage that is named differently from memory addresses, and other information sources. Embodiments directed to automated profiling of features using hardware and memory locations are examples of certain physical ways of recording a particular feature. The concept of hardware based monitoring of feature space may also apply to non-memory mapped means of recording. For example, a PMU unit in a device such as a GPU may track accesses to a texture cache if the texture cache is used to store various features.

In some embodiments, monitoring of a network, such as a neural network, can be applied at multiple levels of the network. In this way, an attention graph can be built up across multiple layers and displayed on a console or logged/archived for deferred consulting, forensics, etc. Further, if a given model is itself feeding into an ensemble decision maker, then deviations of this model from majority decisions can be treated as possible errors, and the above analysis can also be used to identify or record when the attention provided or not provided to different factors most closely correlates with errors. This allows both learning over time, and documentation of that learning, as mapped back to human understandable factors.

It is noted that because the monitoring is performed in hardware, the monitoring can be attested to with hardware-based strong integrity protections, such as with TEE (Trusted Execution Environment) public key signatures. In this way the originating aspects of training, as well as inference time decisions, can be automated and maintained, and a trace of their training can be made available when required for verification, discovery processes, arbitration, policy compliance, and other operations requiring strong chains of custody.

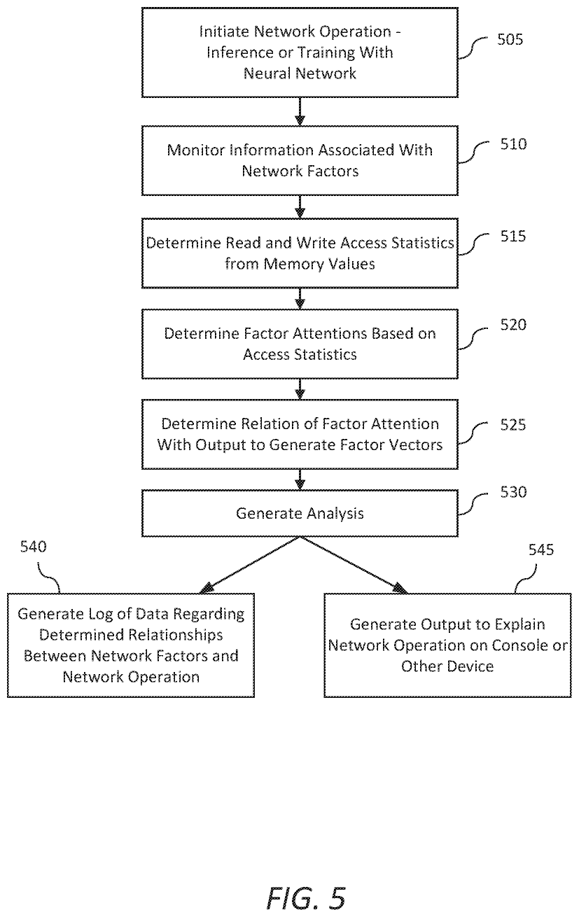

FIG. 5 is a flowchart to illustrate a process for of monitoring and analysis of a network such as a neural network according to some embodiments. As illustrated in FIG. 5, a process includes initiating a network operation, which may include, for example, inference or training operation by a neural network 505. The process further includes monitoring information associated with network factors 510, wherein the monitoring may be providing by a performance monitoring unit (PMU). Monitoring information may include, but is not limited to, monitoring variables in a data storage. Network monitoring may be, for example, as illustrated in one or more of FIGS. 1-4.

In some embodiments, read and write access statistics are determined from the monitored memory values 515, and attention for network factors are determined based on the access statistics 520. The process may proceed with the determination of the relationship of factor attentions to the output of the network 525, thereby generating factor vectors that relate the effect of certain factors on the output. In some embodiments, an analysis regarding the network operation in relation to the network factors is generated based on the factor vectors 530.

Further, the analysis that is generated may be provided to one or more output destinations, such as generation of a log of data regarding the determined relationships between network factors and network operation 540 or generation of an output to a console or other device explaining neural network operation 545.

System Overview

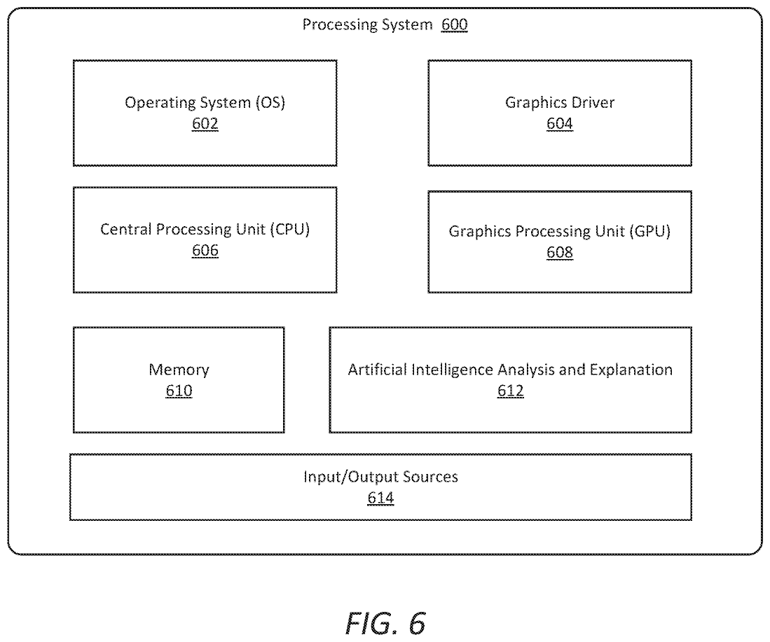

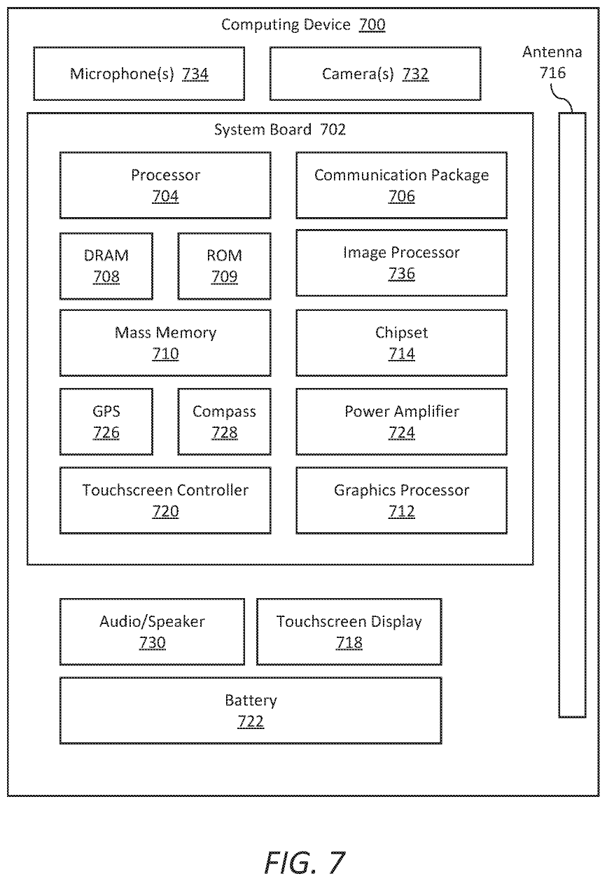

FIG. 6 illustrates artificial intelligence analysis and explanation utilizing hardware measures of attention in a processing system according to some embodiments. For example, in one embodiment, artificial intelligence (AI) analysis and explanation 612 of FIG. 6 may be employed or hosted by a processing system 600, which may include, for example, computing device 700 of FIG. 7. In some embodiments, AI analysis and explanation 612 utilizes measures of attention for AI network factors to provide explanation for operation of the AI network as shown in connection with description of FIGS. 1-5 above. Processing system 600 represents a communication and data processing device including or representing any number and type of smart devices, such as (without limitation) smart command devices or intelligent personal assistants, home/office automation system, home appliances (e.g., security systems, washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet based cable television set-top boxes, etc.), global positioning system (GPS)-based devices, etc.

In some embodiments, processing system 600 may include (without limitation) autonomous machines or artificially intelligent agents, such as a mechanical agents or machines, electronics agents or machines, virtual agents or machines, electro-mechanical agents or machines, etc. Examples of autonomous machines or artificially intelligent agents may include (without limitation) robots, autonomous vehicles (e.g., self-driving cars, self-flying planes, self-sailing boats or ships, etc.), autonomous equipment (self-operating construction vehicles, self-operating medical equipment, etc.), and/or the like. Further, “autonomous vehicles” are not limited to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, processing system 600 may include a cloud computing platform consisting of a plurality of server computers, where each server computer employs or hosts a multifunction perceptron mechanism. For example, automatic ISP tuning may be performed using component, system, and architectural setups described earlier in this document. For example, some of the aforementioned types of devices may be used to implement a custom learned procedure, such as using field-programmable gate arrays (FPGAs), etc.

Further, for example, processing system 600 may include a computer platform hosting an integrated circuit (“IC”), such as a system on a chip (“SoC” or “SOC”), integrating various hardware and/or software components of computing device 600 on a single chip.

As illustrated, in one embodiment, processing system 600 may include any number and type of hardware and/or software components, such as (without limitation) graphics processing unit 608 (“GPU” or simply “graphics processor”), graphics driver 604 (also referred to as “GPU driver”, “graphics driver logic”, “driver logic”, user-mode driver (UMD), user-mode driver framework (UMDF), or simply “driver”), central processing unit 606 (“CPU” or simply “application processor”), memory 610, network devices, drivers, or the like, as well as input/output (IO) sources 614, such as touchscreens, touch panels, touch pads, virtual or regular keyboards, virtual or regular mice, ports, connectors, etc. Processing system 600 may include operating system (OS) 602 serving as an interface between hardware and/or physical resources of processing system 600 and a user.

It is to be appreciated that a lesser or more equipped system than the example described above may be preferred for certain implementations. Therefore, the configuration of processing system 600 may vary from implementation to implementation depending upon numerous factors, such as price constraints, performance requirements, technological improvements, or other circumstances.

Embodiments may be implemented as any or a combination of: one or more microchips or integrated circuits interconnected using a system board, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

In one embodiment, AI analysis and explanation 612 may be hosted by memory 610 of processing system 600. In another embodiment, AI analysis and explanation 612 may be hosted by or be part of operating system 602 of processing system 600. In another embodiment, AI analysis and explanation 612 may be hosted or facilitated by graphics driver 604. In yet another embodiment, AI analysis and explanation 612 may be hosted by or part of graphics processing unit 608 (“GPU” or simply “graphics processor”) or firmware of graphics processor 608. For example, AI analysis and explanation 612 may be embedded in or implemented as part of the processing hardware of graphics processor 608. Similarly, in yet another embodiment, AI analysis and explanation 612 may be hosted by or part of central processing unit 606 (“CPU” or simply “application processor”). For example, AI analysis and explanation 612 may be embedded in or implemented as part of the processing hardware of application processor 606.

In yet another embodiment, AI analysis and explanation 612 may be hosted by or part of any number and type of components of processing system 600, such as a portion of AI analysis and explanation 612 may be hosted by or part of operating system 602, another portion may be hosted by or part of graphics processor 608, another portion may be hosted by or part of application processor 606, while one or more portions of AI analysis and explanation 612 may be hosted by or part of operating system 602 and/or any number and type of devices of processing system 600. It is contemplated that embodiments are not limited to certain implementation or hosting of AI analysis and explanation 612 and that one or more portions or components of AI analysis and explanation 612 may be employed or implemented as hardware, software, or any combination thereof, such as firmware.

Processing system 600 may host network interface(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), 5th Generation (5G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media (including a non-transitory machine-readable or computer-readable storage medium) having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic tape, magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

FIG. 7 illustrates a computing device according to some embodiments. It is contemplated that details of computing device 700 may be the same as or similar to details of processing system 600 of FIG. 6 and thus for brevity, certain of the details discussed with reference to processing system 600 of FIG. 6 are not discussed or repeated hereafter. Computing device 700 houses a system board 702 (which may also be referred to as a motherboard, main circuit board, or other terms)). The board 702 may include a number of components, including but not limited to a processor 704 and at least one communication package or chip 706. The communication package 706 is coupled to one or more antennas 716. The processor 704 is physically and electrically coupled to the board 702.

Depending on its applications, computing device 700 may include other components that may or may not be physically and electrically coupled to the board 702. These other components include, but are not limited to, volatile memory (e.g., DRAM) 708, nonvolatile memory (e.g., ROM) 709, flash memory (not shown), a graphics processor 712, a digital signal processor (not shown), a crypto processor (not shown), a chipset 714, an antenna 716, a display 718 such as a touchscreen display, a touchscreen controller 720, a battery 722, an audio codec (not shown), a video codec (not shown), a power amplifier 724, a global positioning system (GPS) device 726, a compass 728, an accelerometer (not shown), a gyroscope (not shown), a speaker or other audio element 730, one or more cameras 732, a microphone array 734, and a mass storage device (such as hard disk drive) 710, compact disk (CD) (not shown), digital versatile disk (DVD) (not shown), and so forth). These components may be connected to the system board 702, mounted to the system board, or combined with any of the other components.

The communication package 706 enables wireless and/or wired communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 706 may implement any of a number of wireless or wired standards or protocols, including but not limited to Wi-Fi (IEEE 802.11 family), WiMAX (IEEE 802.16 family), IEEE 802.20, long term evolution (LTE), Ev-DO (Evolution Data Optimized), HSPA+, HSDPA+, HSUPA+, EDGE Enhanced Data rates for GSM evolution), GSM (Global System for Mobile communications), GPRS (General Package Radio Service), CDMA (Code Division Multiple Access), TDMA (Time Division Multiple Access), DECT (Digital Enhanced Cordless Telecommunications), Bluetooth, Ethernet derivatives thereof, as well as any other wireless and wired protocols that are designated as 3G, 4G, 5G, and beyond. The computing device 700 may include a plurality of communication packages 706. For instance, a first communication package 706 may be dedicated to shorter range wireless communications such as Wi-Fi and Bluetooth and a second communication package 706 may be dedicated to longer range wireless communications such as GSM, EDGE, GPRS, CDMA, WiMAX, LTE, Ev-DO, and others.

The cameras 732 including any depth sensors or proximity sensor are coupled to an optional image processor 736 to perform conversions, analysis, noise reduction, comparisons, depth or distance analysis, image understanding, and other processes as described herein. The processor 704 is coupled to the image processor to drive the process with interrupts, set parameters, and control operations of image processor and the cameras. Image processing may instead be performed in the processor 704, the graphics processor 712, the cameras 732, or in any other device.

In various implementations, the computing device 700 may be a laptop, a netbook, a notebook, an Ultrabook, a smartphone, a tablet, a personal digital assistant (PDA), an ultra-mobile PC, a mobile phone, a desktop computer, a server, a set-top box, an entertainment control unit, a digital camera, a portable music player, or a digital video recorder. The computing device may be fixed, portable, or wearable. In further implementations, the computing device 700 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

Machine Learning—Deep Learning

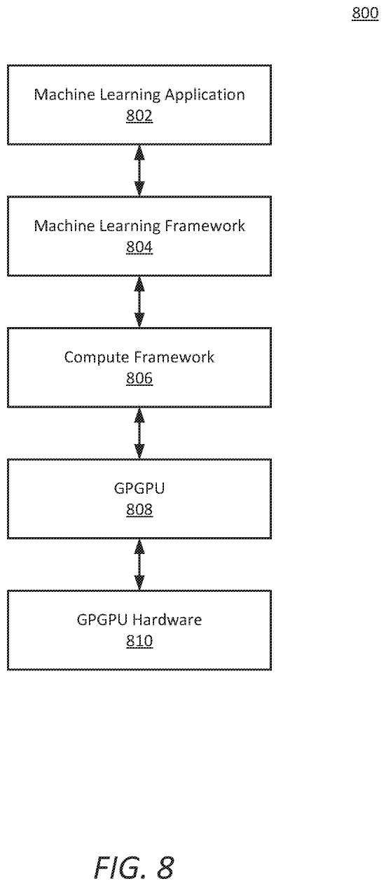

FIG. 8 is a generalized diagram of a machine learning software stack. FIG. 8 illustrates a software stack 800 for GPGPU operation. However, a machine learning software stack is not limited to this example, and may include, for also, a machine learning software stack for CPU operation.

A machine learning application 802 can be configured to train a neural network using a training dataset or to use a trained deep neural network to implement machine intelligence. The machine learning application 802 can include training and inference functionality for a neural network and/or specialized software that can be used to train a neural network before deployment. The machine learning application 802 can implement any type of machine intelligence including but not limited to image recognition, mapping and localization, autonomous navigation, speech synthesis, medical imaging, or language translation.

Hardware acceleration for the machine learning application 802 can be enabled via a machine learning framework 804. The machine learning framework 804 can provide a library of machine learning primitives. Machine learning primitives are basic operations that are commonly performed by machine learning algorithms. Without the machine learning framework 804, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 804. Exemplary primitives include tensor convolutions, activation functions, and pooling, which are computational operations that are performed while training a convolutional neural network (CNN). The machine learning framework 804 can also provide primitives to implement basic linear algebra subprograms performed by many machine-learning algorithms, such as matrix and vector operations.

The machine learning framework 804 can process input data received from the machine learning application 802 and generate the appropriate input to a compute framework 806. The compute framework 806 can abstract the underlying instructions provided to the GPGPU driver 808 to enable the machine learning framework 804 to take advantage of hardware acceleration via the GPGPU hardware 810 without requiring the machine learning framework 804 to have intimate knowledge of the architecture of the GPGPU hardware 810. Additionally, the compute framework 806 can enable hardware acceleration for the machine learning framework 804 across a variety of types and generations of the GPGPU hardware 810.

Machine Learning Neural Network Implementations

The computing architecture provided by embodiments described herein can be configured to perform the types of parallel processing that is particularly suited for training and deploying neural networks for machine learning. A neural network can be generalized as a network of functions having a graph relationship. As is known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for compute vision and image recognition applications, but they also may be used for other types of pattern recognition such as speech and language processing. The nodes in the CNN input layer are organized into a set of “filters” (feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described below present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

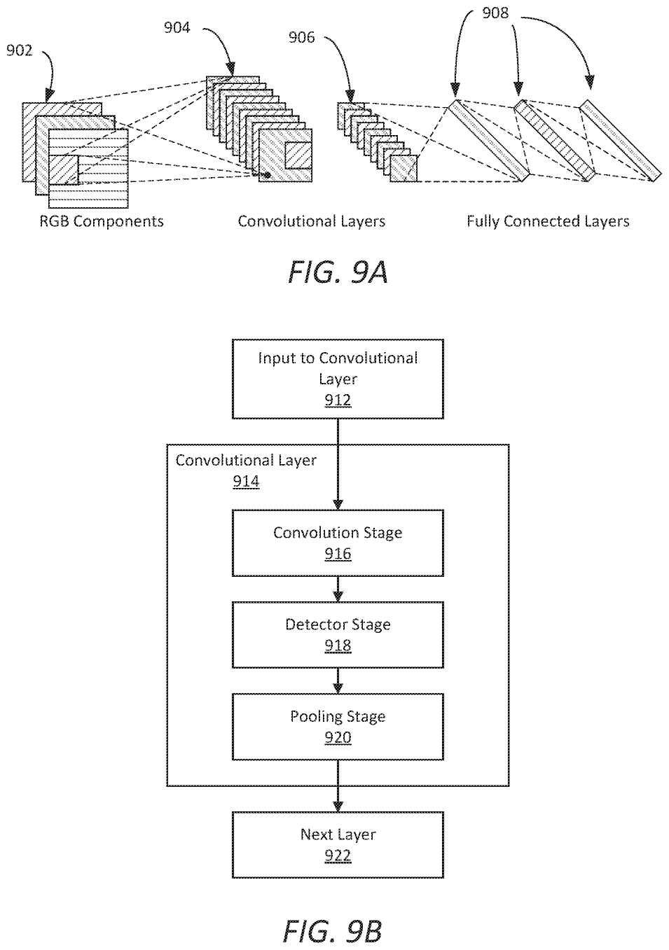

FIGS. 9A-9B illustrate an exemplary convolutional neural network. FIG. 9A illustrates various layers within a CNN. As shown in FIG. 9A, an exemplary CNN used to model image processing can receive input 902 describing the red, green, and blue (RGB) components of an input image. The input 902 can be processed by multiple convolutional layers (e.g., first convolutional layer 904, second convolutional layer 906). The output from the multiple convolutional layers may optionally be processed by a set of fully connected layers 908. Neurons in a fully connected layer have full connections to all activations in the previous layer, as previously described for a feedforward network. The output from the fully connected layers 908 can be used to generate an output result from the network. The activations within the fully connected layers 908 can be computed using matrix multiplication instead of convolution. Not all CNN implementations are make use of fully connected layers 908. For example, in some implementations the second convolutional layer 906 can generate output for the CNN.

The convolutional layers are sparsely connected, which differs from traditional neural network configuration found in the fully connected layers 908. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The kernels associated with the convolutional layers perform convolution operations, the output of which is sent to the next layer. The dimensionality reduction performed within the convolutional layers is one aspect that enables the CNN to scale to process large images.

FIG. 9B illustrates exemplary computation stages within a convolutional layer of a CNN. Input to a convolutional layer 912 of a CNN can be processed in three stages of a convolutional layer 914. The three stages can include a convolution stage 916, a detector stage 918, and a pooling stage 920. The convolution layer 914 can then output data to a successive convolutional layer. The final convolutional layer of the network can generate output feature map data or provide input to a fully connected layer, for example, to generate a classification value for the input to the CNN.

In the convolution stage 916 performs several convolutions in parallel to produce a set of linear activations. The convolution stage 916 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 916 defines a set of linear activations that are processed by successive stages of the convolutional layer 914.

The linear activations can be processed by a detector stage 918. In the detector stage 918, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined as ƒ(x)=max(0, x), such that the activation is thresholded at zero.

The pooling stage 920 uses a pooling function that replaces the output of the second convolutional layer 906 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 920, including max pooling, average pooling, and l2-norm pooling. Additionally, some CNN implementations do not include a pooling stage. Instead, such implementations substitute and additional convolution stage having an increased stride relative to previous convolution stages.

The output from the convolutional layer 914 can then be processed by the next layer 922. The next layer 922 can be an additional convolutional layer or one of the fully connected layers 908. For example, the first convolutional layer 904 of FIG. 9A can output to the second convolutional layer 906, while the second convolutional layer can output to a first layer of the fully connected layers 908.

The following clauses and/or examples pertain to further embodiments or examples. Specifics in the examples may be applied anywhere in one or more embodiments. The various features of the different embodiments or examples may be variously combined with certain features included and others excluded to suit a variety of different applications. Examples may include subject matter such as a method, means for performing acts of the method, at least one machine-readable medium, such as a non-transitory machine-readable medium, including instructions that, when performed by a machine, cause the machine to perform acts of the method, or of an apparatus or system for facilitating operations according to embodiments and examples described herein.

In some embodiments, one or more non-transitory computer-readable storage mediums have stored thereon executable computer program instructions that, when executed by one or more processors, cause the one or more processors to perform operations including monitoring information relating to one or more factors of an artificial intelligence (AI) network during operation of the network, the network to receive input data and output a decision based at least in part on the input data; determining attention received by the one or more factors of the network during the operation of the network based at least in part on the monitored information; determining one or more relationships between the attention received by the one or more factors and a decision of the network; and generating an analysis of the operation of the network based at least in part on the one or more relationships between attention received by the one or more factors and the decision of the network.

In some embodiments, the attention for a factor includes measurement of a level of access to the factor during the operation of the network.

In some embodiments, determining the one or more relationships includes generating one or more factor vectors, a factor vector indicating a grade or measure of attention that is received by a factor of one or more factors in generating the decision of the network with a corresponding set of input data.

In some embodiments, the one or more mediums include instructions for generating access statistics for the monitored information.

In some embodiments, the monitoring of information includes one or more of monitoring a data store, IP blocks, or code addresses.

In some embodiments, the monitored information includes data in a data storage, and the access statistics include read statistics and write statistics for the variables in the data storage.

In some embodiments, operation of the network includes one or both of training and inference or other decisions-making of the network.

In some embodiments, the network is a neural network.

In some embodiments, the one or more mediums include instructions for measuring energy required to generate the decision, wherein the analysis of the operation of the network is further based on the measured energy.

In some embodiments, the monitoring of the variables in the data storage is performed by a performance monitoring unit (PMU).

In some embodiments, the one or more mediums include instructions for measuring energy required to generate the decision, wherein the analysis of the operation of the network is further based on the measured energy.

In some embodiments, the measured energy is a relative energy measurement.

In some embodiments, monitoring variables in a data storage includes compact indication to capture reduced data, the reduced data including less than all data relating to an address.

In some embodiments, the one or more mediums include instructions for directing data regarding analysis of the operation of the network to an output device.

In some embodiments, the one or more mediums include instructions for adding input noise to the input noise; and determining how the attention received by the one or more factors and the decision of the network are affected by the input noise.

In some embodiments, a method includes monitoring variables in a computer memory relating to one or more factors of a neural network during operation of the neural network, the neural network to receive input data and output a decision based at least in part on the input data; determining attention received by the one or more factors of the neural network during the operation of the neural network; determining one or more relationships between the attention received by the one or more factors and a decision of the neural network; generating an analysis of the operation of the neural network based at least in part on the one or more relationships between attention received by the one or more factors and the decision of the neural network; and directing data regarding analysis of the operation of the neural network to an output device.

In some embodiments, the attention for a factor includes measurement of a level of access to the factor during the operation of the neural network.

In some embodiments, determining the one or more relationships includes generating one or more factor vectors, a factor vector indicating a grade or measure of attention that is received by a factor of one or more factors in generating the decision of the neural network with a corresponding set of input data.

In some embodiments, the method further includes generating access statistics for the variables in the data storage.

In some embodiments, monitoring variables in the computer memory includes compact indication to capture reduced data, the reduced data including less than all bits of an address.

In some embodiments, the method further includes measuring energy required to generate the decision, wherein the analysis of the operation of the neural network is further based on the measured energy.

In some embodiments, the method further includes adding input noise to the input noise; and determining how the attention received by the one or more factors and the decision of the network are affected by the input noise.

In some embodiments, a system includes one or more processors to process data; a memory to store data, including data for a neural network; and a performance monitoring unit (PMU) to monitor variables in the memory relating to one or more factors of a neural network during operation of the neural network, the neural network to receive input data and output a decision based at least in part on the input data, wherein the system is to determine attention received by the one or more factors of the neural network during the operation of the neural network; determine one or more relationships between the attention received by the one or more factors and a decision of the neural network; and generate an analysis of the operation of the neural network based at least in part on the one or more relationships between attention received by the one or more factors and the decision of the neural network.

In some embodiments, the attention for a factor includes measurement of a level of access to the factor during the operation of the neural network.

In some embodiments, wherein determining the one or more relationships includes generating one or more factor vectors, a factor vector indicating a grade or measure of attention that is received by a factor of one or more factors in generating the decision of the network with a corresponding set of input data.

In some embodiments, the system is further to measure energy required to generate the decision, wherein the analysis of the operation of the neural network is further based on the measured energy.

In some embodiments, the system further includes an output device to receive analysis of the operation of the neural network.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer. In some embodiments, a non-transitory computer-readable storage medium has stored thereon data representing sequences of instructions that, when executed by a processor, cause the processor to perform certain operations.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

What is claimed is:

1. One or more non-transitory computer-readable storage mediums having stored thereon executable computer program instructions that, when executed by one or more processors, cause the one or more processors to perform operations comprising:
monitoring information relating to one or more factors of an artificial intelligence (AI) network during operation of the network, the network to receive input data and output a decision based at least in part on the input data;
determining attention received by the one or more factors of the network during the operation of the network based at least in part on the monitored information;
determining one or more relationships between the attention received by the one or more factors and a decision of the network; and
generating an analysis of the operation of the network based at least in part on the one or more relationships between attention received by the one or more factors and the decision of the network.

2. The one or more mediums of claim 1, wherein the attention for a factor includes measurement of a level of access to the factor during the operation of the network.

3. The one or more mediums of claim 1, wherein determining the one or more relationships includes generating one or more factor vectors, a factor vector indicating a grade or measure of attention that is received by a factor of one or more factors in generating the decision of the network with a corresponding set of input data.

4. The one or more mediums of claim 1, further comprising executable computer program instructions that, when executed by the one or more processors, cause the one or more processors to perform operations comprising:
generating access statistics for the monitored information.

5. The one or more mediums of claim 1, wherein the monitoring of information includes one or more of monitoring a data store, IP blocks, or code addresses.

6. The one or more mediums of claim 4, wherein the monitored information includes data in a data storage, and wherein the access statistics include read statistics and write statistics for variables in the data storage.

7. The one or more mediums of claim 1, wherein operation of the network includes one or both of training and inference or other decisions-making of the network.

8. The one or more mediums of claim 7, wherein the network is a neural network.

9. The one or more mediums of claim 7, further comprising executable computer program instructions that, when executed by the one or more processors, cause the one or more processors to perform operations comprising:
upon determining that one or more factors are not receiving enough attention during training of the network, augmenting the input data with additional examples of the one or more factors to address the attention deficiency.

10. The one or more mediums of claim 1, wherein the monitoring of the variables in the data storage is performed by a performance monitoring unit (PMU).

11. The one or more mediums of claim 1, further comprising executable computer program instructions that, when executed by the one or more processors, cause the one or more processors to perform operations comprising:
measuring energy required to generate the decision, wherein the analysis of the operation of the network is further based on the measured energy.

12. The one or more mediums of claim 11, wherein the measured energy is a relative energy measurement.

13. The one or more mediums of claim 1, wherein monitoring variables in a data storage includes compact indication to capture reduced data, the reduced data including less than all data relating to an address.

14. The one or more mediums of claim 1, further comprising executable computer program instructions that, when executed by the one or more processors, cause the one or more processors to perform operations comprising:
directing data regarding analysis of the operation of the network to an output device.

15. The one or more mediums of claim 1, further comprising executable computer program instructions that, when executed by the one or more processors, cause the one or more processors to perform operations comprising:
adding input noise to the input noise; and
determining how the attention received by the one or more factors and the decision of the network are affected by the input noise.

16. A method comprising:
monitoring variables in a computer memory relating to one or more factors of a neural network during operation of the neural network, the neural network to receive input data and output a decision based at least in part on the input data;
determining attention received by the one or more factors of the neural network during the operation of the neural network;
determining one or more relationships between the attention received by the one or more factors and a decision of the neural network;
generating an analysis of the operation of the neural network based at least in part on the one or more relationships between attention received by the one or more factors and the decision of the neural network; and
directing data regarding analysis of the operation of the neural network to an output device.

17. The method of claim 16, wherein the attention for a factor includes measurement of a level of access to the factor during the operation of the neural network.

18. The method of claim 16, further comprising:
generating access statistics for the variables in the data storage.

19. The method of claim 16, further comprising:
measuring energy required to generate the decision, wherein the analysis of the operation of the neural network is further based on the measured energy.

20. The method of claim 16, further comprising:
adding input noise to the input noise; and
determining how the attention received by the one or more factors and the decision of the network are affected by the input noise.

21. A system comprising:
one or more processors to process data;
a memory to store data, including data for a neural network; and
a performance monitoring unit (PMU) to monitor variables in the memory relating to one or more factors of a neural network during operation of the neural network, the neural network to receive input data and output a decision based at least in part on the input data;
wherein the system is to:
determine attention received by the one or more factors of the neural network during the operation of the neural network;
determine one or more relationships between the attention received by the one or more factors and a decision of the neural network; and
generate an analysis of the operation of the neural network based at least in part on the one or more relationships between attention received by the one or more factors and the decision of the neural network.

22. The system of claim 21, wherein the attention for a factor includes measurement of a level of access to the factor during the operation of the neural network.

23. The system of claim 21, wherein determining the one or more relationships includes generating one or more factor vectors, a factor vector indicating a grade or measure of attention that is received by a factor of one or more factors in generating the decision of the neural network with a corresponding set of input data.

24. The system of claim 21, wherein the system is further to:
measure energy required to generate the decision, wherein the analysis of the operation of the neural network is further based on the measured energy.

25. The system of claim 21, further comprising an output device to receive analysis of the operation of the neural network.
